(19) United States
(12) Patent Application Publication
(10) Pub. No.: US 2018/0143430 A1
(43) Pub. Date: May 24, 2018

(54) PRE-CAPTURE DE-IDENTIFICATION (PCDI) IMAGING SYSTEM AND PCDI OPTICS ASSEMBLY

(71) Applicant: University of Florida Research Foundation, Inc., Gainesville, FL (US)

(72) Inventors: Sanjeev Jagannatha KOPPAL, Gainesville, FL (US); Francesco PITTALUGA, Gainesville, FL (US)

(21) Appl. No.: 15/577,019

(22) PCT Filed: May 26, 2016
(86) PCT No.: PCT/US16/34254

§ 371 Date: Nov. 27, 2017

Related U.S. Application Data
(60) Provisional application No. 62/166,224, filed on May 26, 2015.

(51) Int. Cl. G02B 27/01; G02B 27/14; G06F 17/30; G02B 27/09

(52) U.S. Cl. CPC G02B 27/01; G02B 27/09; G06F 17/30259; G02B 27/14

(57) ABSTRACT

A de-identification assembly comprising an object tracking sensor (435) to track features of an object; and a mask generator (432) to produce rays of light in response to the tracked features of the object, the rays of light representing a de-identification mask of the object. The assembly includes a beamsplitter (422) having a first side configured to receive rays of light representing the object and a second side configured to receive the rays of light of the mask from the mask generator (432). The beamsplitter (422) produces a composite image of the object superimposed with the de-identification mask to anonymize an image of the object. A system including the de-identification assembly and a method are also provided.

### CROSS-REFERENCE TO RELATED APPLICATIONS

This application claims benefit of U.S. Provisional Application No. 62/166,224 filed May 26, 2015, titled “PRE-CAPTURE DE-IDENTIFICATION (PCDI) IMAGING SYSTEM AND PCDI OPTICS ASSEMBLY,” incorporated herein by reference as if set forth in full below.

### BACKGROUND

Embodiments relate to a pre-capture de-identification image system, pre-capture optics assembly and methods of use.

The general public has concerns about their privacy with the wide spread use of camera or video enabled computing devices. Furthermore, privacy of citizens is always challenged with the balance to protect society as a whole.

There is also concern for privacy as the information is collected and stored using social media, or for other purposes.

### SUMMARY

Embodiments related to pre-capture de-identification assembly, system and method. An embodiment includes a de-identification assembly comprising: an object tracking sensor to track features of an object; and a mask generator configured to produce rays of light in response to the tracked object, the rays of light representing an de-identification mask of the object, The assembly includes a beamsplitter having a first side configured to receive rays of light representing an object and a second side configured to receive the rays of light from the mask generator. The beamsplitter producing a composite image of the object superimposed with the de-identification mask.

An aspect of the embodiments include a de-identification system comprising: an object tracking sensor to track features of the object. The system includes a mask generator configured to produce rays of light in response to the tracked and extracted features of the object, the rays of light representing a de-identification mask of the object. The system has a beamsplitter having a first side configured to receive rays of light representing an object and a second side configured to receive the rays of light from the mask generator. An imaging device captures an image of the composite image wherein the composite image being anonymized image of the object.

An aspect of the embodiments include a method comprising: tracking, by an object tracking sensor, features of the object; and generating, by a mask generator, rays of light in response to the tracked object, the rays of light representing a de-identification mask of the object. The method includes receiving, at a beamsplitter having a first side, rays of light representing an object; and receiving, at a second side of the beamsplitter, the rays of light from the mask generator. The method includes generating, by the beamsplitter, a composite image of the object superimposed with the de-identification mask

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 illustrates a block diagram of the pre-capture de-identifying (PCDI) imaging system;

FIG. 2A illustrates a block diagram of smart glasses with a pre-capture de-identifying (PCDI) optics assembly;

FIG. 2B illustrates a security officer having smart glasses with a pre-capture de-identifying (PCDI) optics assembly;

FIG. 2C illustrates a fire and search or rescue person having smart glasses with a pre-capture de-identifying (PCDI) optics assembly;

FIG. 2D illustrate journalist using smart glasses with a pre-capture de-identifying (PCDI) optics assembly;

FIG. 2E illustrates a health care professional using goggles with a pre-capture de-identifying (PCDI) optics assembly;

FIG. 2F illustrates a helmet with an imaging device and pre-capture de-identifying (PCDI) optics assembly;

FIG. 2G illustrates a police officer or security force with an imaging device and pre-capture de-identifying (PCDI) optics assembly;

FIG. 3 illustrates a block diagram of another pre-capture de-identifying (PCDI) system;

FIG. 4A illustrates a ray diagram of the pre-capture de-identifying (PCDI) system;

FIG. 4B illustrates a block diagram of the pre-capture de-identifying (PCDI) optics assembly;

FIG. 5A illustrates a target face;

FIG. 5B illustrates a K-anonymity face mask illuminated by a display;

FIG. 5C illustrates a de-identified target face image;

FIG. 6A illustrates a cylindrical lens in a three-dimensional (3D) printed holder;

FIG. 6B illustrates a cylindrical lens sensor output (one row used);

FIG. 7 illustrates a graph representative of row of cylindrical lens sensor output;

FIG. 8 illustrates a database K-same set of face images;

FIG. 9 illustrates a graph representative of an average between an actual match and best incorrect match;

FIGS. 10A and 10B illustrate an un-aligned and aligned de-identifying image outputs;

FIG. 11A illustrates a target face;

FIG. 11B illustrates a de-identified target face image with K-anonymity faces in a database of FIG. 8;

FIG. 12A illustrates a target face;

FIG. 12B illustrates a de-identified target face image de-identified with K-anonymity faces in a database of FIG. 8;

FIG. 13A-13B illustrate orthographic configurations of the mask generators in relation to the sensor;

FIG. 14A-14B illustrate perspective orthographic configurations of the mask generators in relation to the sensor;

FIG. 15A illustrates a lensless sensor configuration;

FIG. 15B illustrates a lenslet sensor configuration;

FIG. 16 illustrates a computing device;

FIG. 17 illustrates a flow diagram of a process for de-identifying a target face or object without storing the target face or object; and

FIG. 18 illustrates a flow diagram of a process for identifying a member in a membership class database using a de-identified face image.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

The embodiments herein are directed to improvements in computer-related technology and, specifically, to de-identification imaging which saves a digital image of anonymized facial characteristics in memory when a digital image or electronic image of a face is captured by an imaging device. The improvements in computer-related technology are directed to rendering the original facial characteristics anonymous prior to storage in a memory or in a non-transient and tangible computer readable storage medium of an imaging device such as for the preservation of privacy of the individual to which the facial characteristics belong.

The improvements in computer-related technology also include de-identification imaging which saves anonymized images in memory when a digital or electronic image of the object is captured by an imaging device.

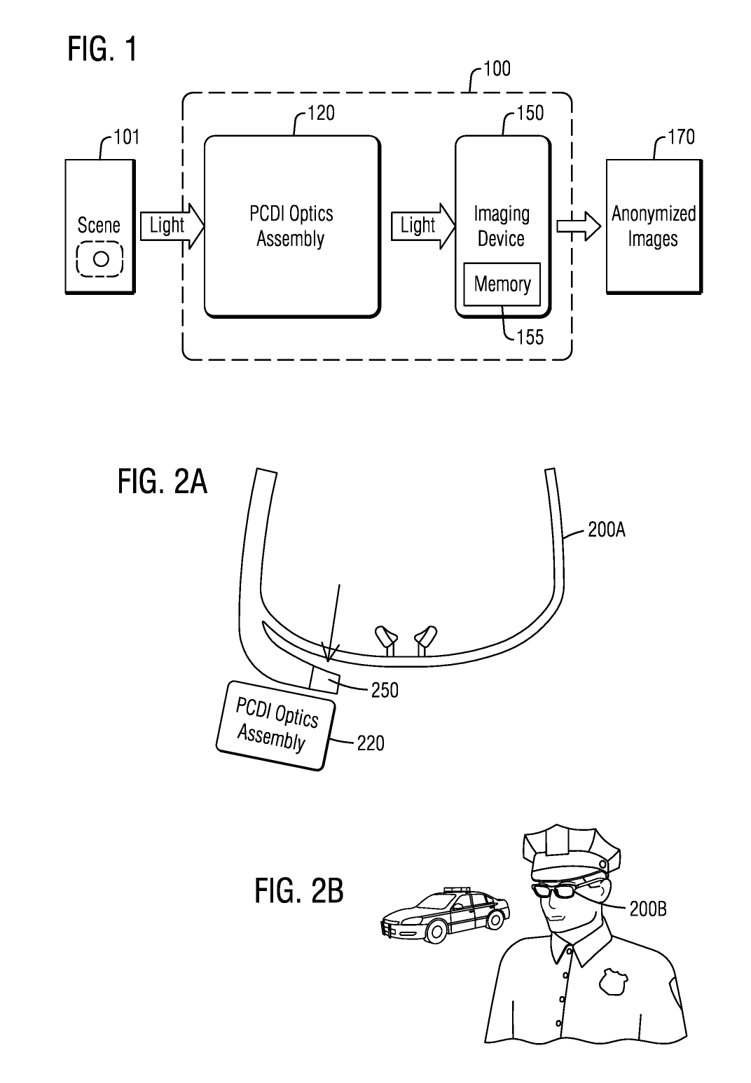

FIG. 1 illustrates a block diagram of the pre-capture de-identifying (PCDI) imaging system 100 denoted in the dashed block. The PCDI imaging system 100 includes a PCDI optics assembly 120 and an imaging device 150. The PCDI optics assembly 120 receives light from scene 101. The scene 101 may be within a field-of-view (FOV) of the imaging device and includes an object O. The de-identifying images 170 may be anonymized images produced as an output of the imaging device 150 and may be stored in memory 155. The PCDI optics assembly 120 communicates light to the image sensors of the imaging device 150, such as a camera, video device, or other image sensing devices. Imaging devices 150 may include photodetectors or photosensors (NOT SHOWN). Other imaging device may include, without limitation, a Microsoft® Kinect® sensor device. The Microsoft® Kinect® sensor device includes an RGB (red, green, blue) camera, time-of-flight depth sensor and microphone array. The object O may be any object that needs to be de-identified. Objects may include faces, vehicles, and buildings, to name a few. The imaging device may be an optical instrument for recording or capturing images or photographs wherein an image may include at least one still image or video (i.e., a sequence of images). The imaging device may store the images locally in memory 55 which may be removable from the imaging device 150. The memory 155 may be permanent to the imaging device 150. The imaging device 150 may transmit images to a remote location. In some embodiments, the remote location may perform additional processing of or store the anonymized image. In one or more embodiments, the memory 155 may be part of a computing device however, the imaging device 150 stores images to a portion of memory shared by the computing device and imaging device 150.

In some embodiments, the imaging device 150 captures an image and stores an image in memory 155 once a button on the imaging device 150 is pressed. In some embodiments, when imaging is automatic, the image being captured and stored may be synchronized or timed to commence after the formation of the composite light with the mask impinging a beamsplitter (i.e., beamsplitter 422) so that only an anonymized image is stored.

The PCDI optics assembly 120 may be a standalone component which may be retrofitted for devices which are camera ready or video enabled such as smart glasses, goggles, helmets, computing devices, etc. In an embodiment, the PCDI imaging system 100 may be provided.

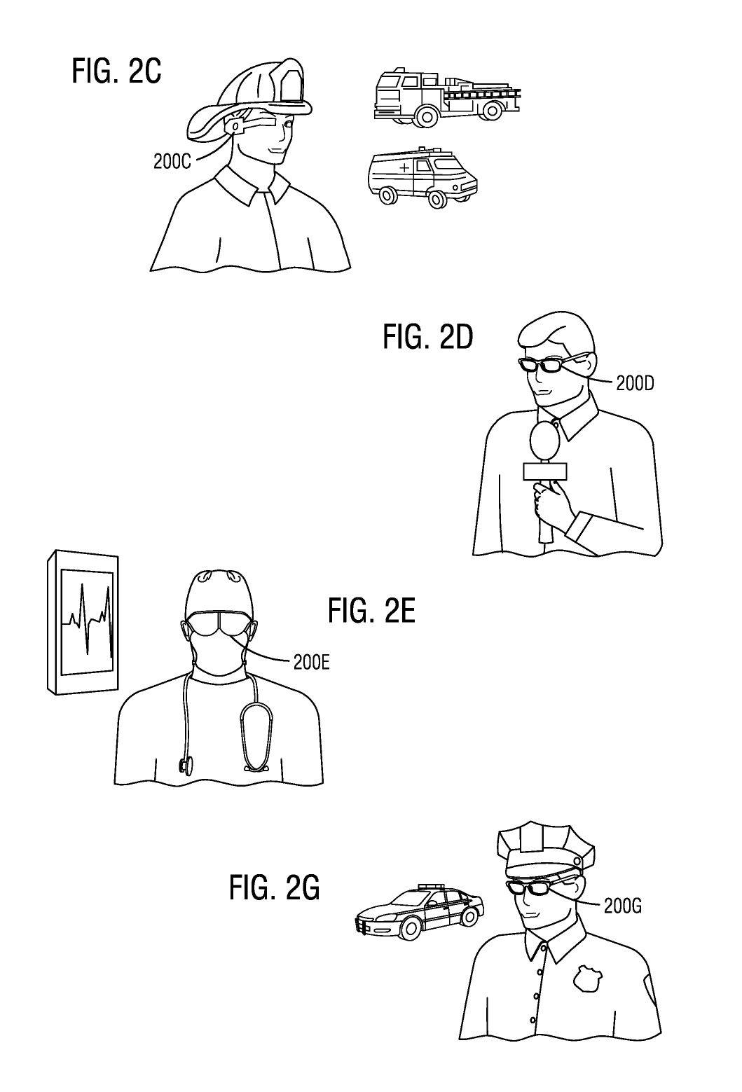

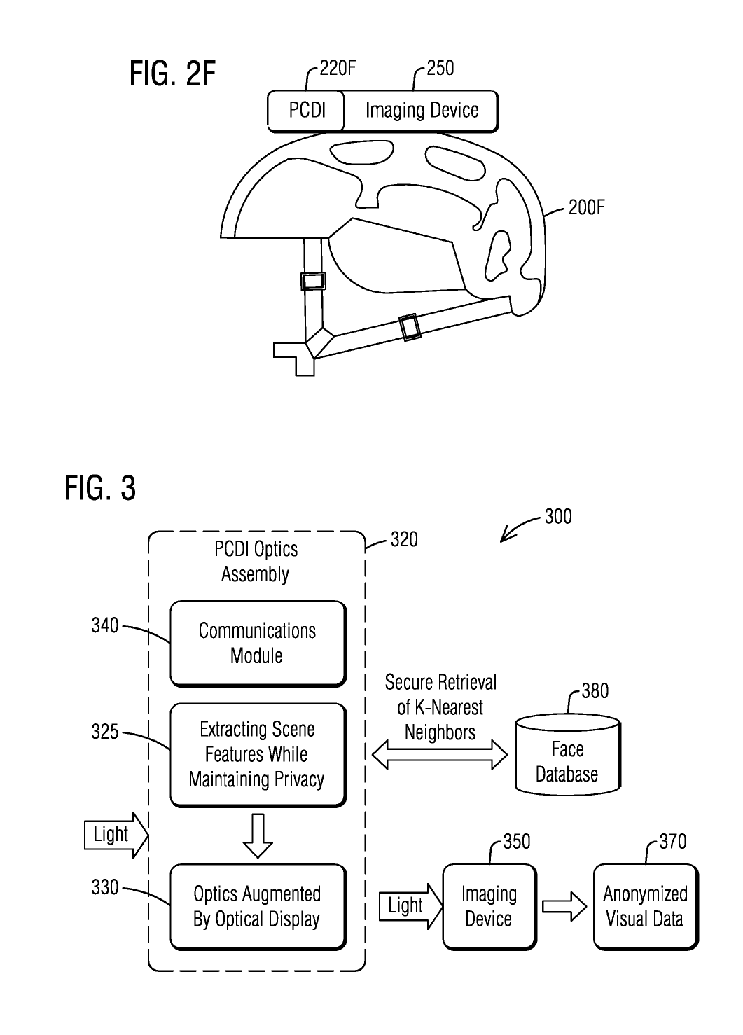

FIG. 2A illustrates a block diagram of smart glasses 200A with a PCDI optics assembly 220 in front of the lens of imaging device 250. Smart glasses 200A may include a camera, image capturing device or video device. The PCDI optics assembly 220 may be used with devices (i.e., smart glasses) which are already equipped with an imaging device 250. The inventors have discovered that there is concern by the public relating to the widespread use of cameras on hand-held and wearable devices. Use of cameras can be particularly a concern for certain religious societies that want to embrace technology but have concerns with capturing images of their female population. Many societies also have concerns over the unauthorized capture of children using imaging devices.

FIG. 2B illustrates a security officer having smart glasses 200B equipped with PCDI optics assembly (i.e., PCDI optics assembly 120). Currently, security officers such as a police officer may include an imaging device which is may be head worn or other wearable mobile computing devices. In such an embodiment, the PCDI assembly would be placed in front of the lens of the imaging device. Therefore, persons being captured are de-identified without ever saving the original facial characteristics or image in memory of an imaging device.

FIG. 2C illustrates a fire and search or rescue person having smart glasses 200C with a PCDI optics assembly (i.e., PCDI optics assembly 120).

FIG. 2D illustrate journalist using smart glasses with a PCDI optics assembly. The PCDI optics assembly (i.e., PCDI optics assembly 120) may be interfaced with smart glasses. The PCDI optics assembly would allow a journalist to interview a witness or interviewee while maintaining the identity of the witness or a person interviewed, for example, private by privatizing the facial characteristics without capturing the image and likeness of the person.

FIG. 2E illustrates a health care professional using goggles 200D with a PCDI optics assembly (i.e., PCDI optics assembly 120). In health care industry, surgery may be captured on video/camera such as for a teaching tool. In such an embodiment, the identity of the patient may be kept private by using the PCDI optics assembly with head worn glasses or goggles enabled with a camera/video device. The video would still capture a generally normal looking face so that the students are not distracted from blacked out sections over the face.

FIG. 2F illustrates a helmet 200F with an imaging device 250. PCDI optics assembly 220F may be configured for placement in front of the lens of the imaging device 250. When security personnel including, by way of non-limiting example, police officers or military soldiers are in the field, video/camera equipped helmets are worn which may capture various citizens which invades their privacy. Using the PCDI optics assembly 220F would de-identify faces in the captured image without the actual face of the person ever being stored in memory or non-transient, tangible computer readable medium of an imaging device.

FIG. 2G illustrates a police officer, security force officer, or military soldier with body-worn imaging device with a PCDI optics assembly. Recently there has been a call for body worn video/camera devices for police. However, widespread use of video/camera devices may invade the public's privacy. The PCDI optics assembly would de-identify faces in captured images such that the original facial characteristics would never be stored in memory.

Several different scenarios have been described above regarding how the PCDI optics assembly 120 or PCDI system 100 can be used. The scenarios are for illustrative purposes and are not limited to the specific scenarios described. By way of non-limiting example, the PCDI optics assembly 120 or PCDI imaging system 100 may be used in airports or areas of video surveillance. For example, Transportation Security Agency (TSA) agents can capture facial characteristics and de-identify faces to protect the public, as will be described in more detail later.

While the above description is related to an existing imaging devices that can be interfaced with a PCDI optics assembly 120, in an embodiment, the imaging device and PCDI optics assembly 120 may be integrated into a system that may be integrated in a helmet, visor, clothing, goggles, glasses, etc. The PCDI optics assembly 120 may be interfaced with a camera/video enabled mobile phone device. The imaging device 150 may be standalone or part of a camera/video enabled computing device such as a personal computer, tablet, mobile phone device or gaming device. Thus, the memory or computer readable medium of the imaging device 150 may be part of the memory of the computing device, personal computer, tablet, mobile device or gaming device.

In another embodiment, the PCDI imaging system 100 may be a standalone system.

FIG. 3 illustrates a block diagram of another pre-capture de-identifying (PCDI) system 300. The PCDI system 300 includes a PCDI optics assembly 320 and an imaging device 350. The system 300 further includes a communication module 340 and a face database 380 which may be remote from the system 300. In an embodiment, the face database 380 may be resident with the system 300. The PCDI optics 330 includes a beamsplitter and display device, as described in more detail below. The PCDI optics assembly also includes an extracting scene features component 325. The extracting scene features component 325 is configured to track the object's features in a private manner so that the identity of the object is not stored or determinable. The imaging device 350 produces an anonymized visual data 370 which may be stored. The scene features extracted by the extracting scene features component 325 may detect face alignment features that can be obtained while maintaining privacy. The face database 380 may include a plurality of faces that are similar so that a de-identification mask may be generated such that the mask is anatomically aligned (such as the eyes, nose, mouth, chin, eyebrows, etc.) with the face in the scene. This applies for other objects. The database should include a data set large enough to obtain a plurality of similar objects to create a mask. The mask is an imitation de-identification mask.

The communication module 340 may contain communication connection(s) that allow the PCDI optics assembly 320 to communicate with other computing devices, such as over a network or a wireless network. By way of example, and not limitation, communication connection(s) may include wired media such as a wired network or direct-wired connection, and wireless media such as acoustic, radio frequency (RF), infrared and other wireless media. The computing device 1650 may include a network interface card 1668 to connect (wired or wireless) to a network, such as the Internet or World Wide Web (WWW).

In an embodiment, the face database 380 may be accessed using a wired or wireless communication protocol. By way of non-limiting example, the face database 380 may be accessed via the communication module 340 via the Internet, an intranet, or other wired or wireless communications network. The database 380 may be an object database such as for vehicles, buildings for creating a mask of an object. The database may be accessed using a web-based application such as when the database is remote.

The PCDI optics assembly 320 may include extracting scene features component 325 and optics augmented by an optical display 330. It should be recognized that in practical applications, the PCDI optics assembly may include many other components and features that have not been expressly illustrated in FIG. 1, which are not included herein for sake of brevity.

The description below assumes that the object is a face.

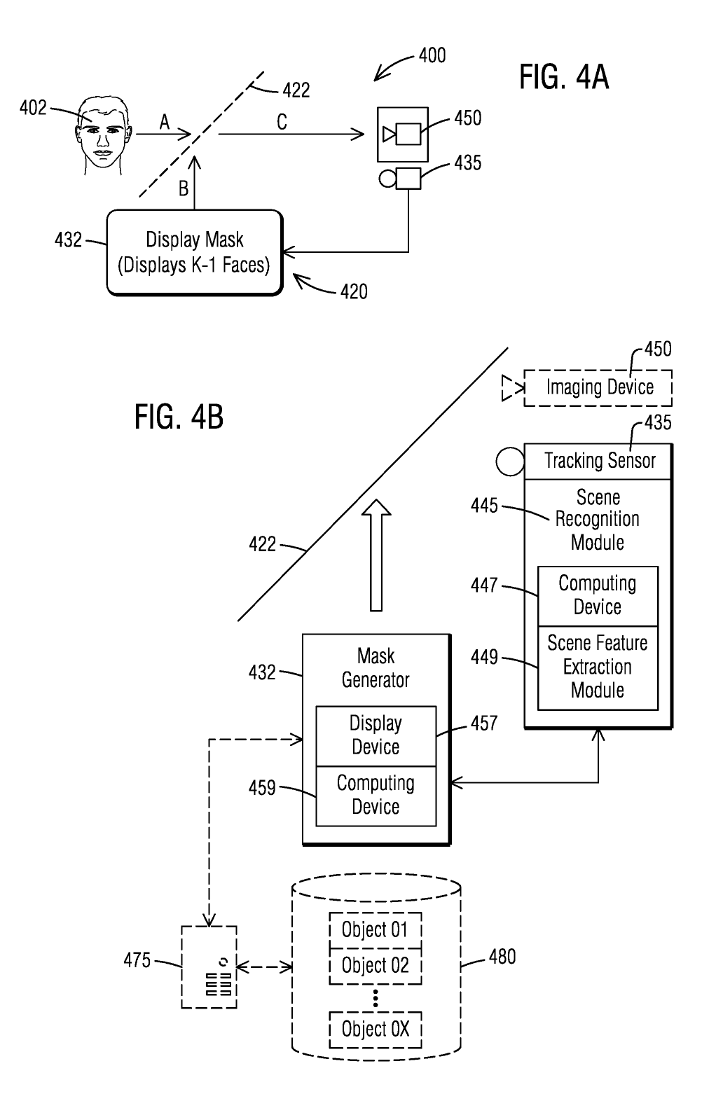

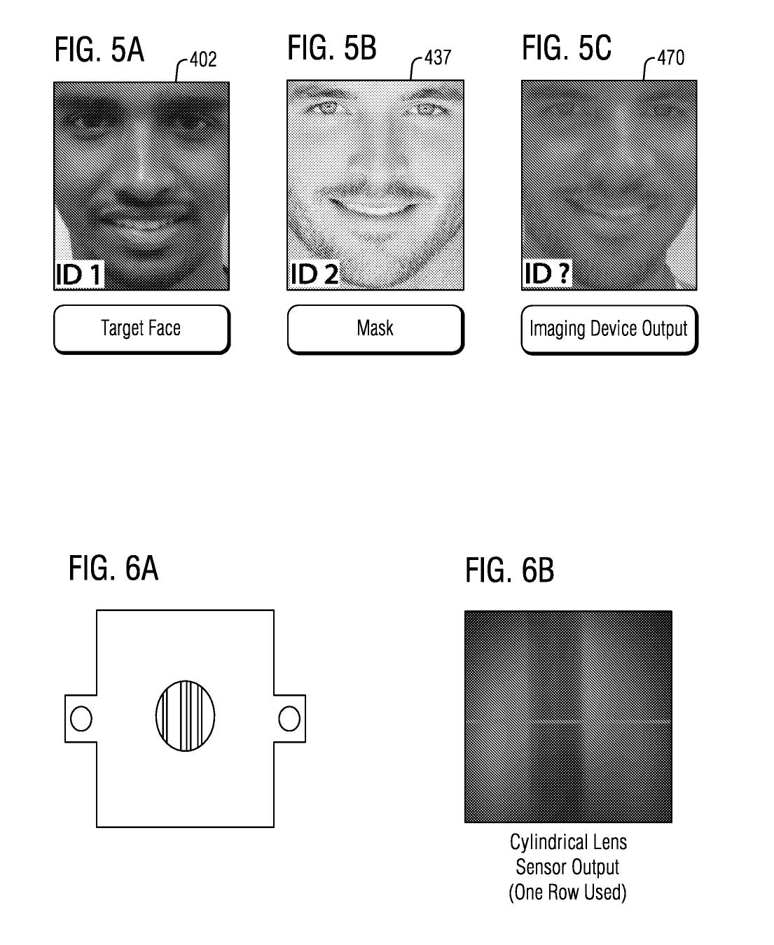

FIG. 4A illustrates a ray diagram of the PCDI system 400. The ray diagram will be described in combination with FIGS. 5A-5C. FIG. 5A illustrates a target face 402. The target face 402 is in the FOV of conventional imaging device 450 such as a camera or video device. PCDI optics assembly 420 may include beamsplitter 422, object tracking sensor 435 and object mask generator 432. The FOV may be a function of the lens of the imaging device 450 through which light passes into the imaging device 450 to a photodetector array or image sensor array. The anonymized image is from the image sensor array of the imaging device 450, where the anonymized image being stored into memory by the imagine device 450 either locally or remotely. The PCDI optics is configured to track features of the head associated with the target face 402 using object tracking sensor 435. The object tracking sensor 435 may track and extract a location, speed, pose, orientation and depth of an object in the scene.

Referring also to FIG. 4B, a block diagram of the pre-capture de-identifying (PCDI) optics assembly 420 is illustrated. In FIG. 4B, the imaging device 450 is denoted in dashed lines as it is not part of the PCDI optics assembly 420. Additionally, in FIG. 4B, the server 475 and a remote database 480 are represented in dashed in dashed lines to denote that the server 475 and remote database 480 are separate from the PCDI optics assembly 420. However, the database 480 may be local to the mask generator 432, in some embodiments.

The mask generator 432 may include a display device 457 and a computing device 459. The computing device 459 (i.e., computing device 1650) is shown coupled to a remote database 480 via server 475, the database 480 having a plurality of objects O1, O2 . . . OX. The database 480 includes the storage device in which electronic data may be stored and the content such as the plurality of object stored in the storage device embodied by the database. In some embodiments, the objects O1, O2 . . . OX may a collection of one of faces, vehicles, building, or other objects. The object may be an image of a thing that may be linked or associated with someone such that privacy is compromised if stored in memory or non-transitory, tangible computer readable medium. The computing device 459 generates an electronic representation of the mask. The display device 457 displays the mask such that the mask is directed toward beamsplitter 422. In some embodiments, communications of the computing device 459 to the server 475 may be performed using a wireless or wired communication protocol, such as through the Internet or other communications infrastructure. The database 480 may employ cloud technology.

In lieu of a remote database 480 accessed via a server 475, a database of objects may be stored locally in the memory of the computing device 459 (i.e., computing device 1650). In such embodiments, the server 475 would be omitted.

In an embodiment, the object tracking sensor 435 may be a privatizing object tracking sensor such that the identity of the object track is privatized without storing identifying information. The object tracking sensor 435 communicates tracking information to the mask generator 432 so that the mask may be aligned with the target face in response to the tracked information. The beamsplitter 422 is oriented at an angle so that the light rays from the mask generator 432 can impinge or impact the beamsplitter 422 surface.

By way of non-limiting example, the object tracking sensor 435 may be a standard object tracking sensor configured to track head motion and features via a scene recognition module 435, however, the lens or aperture of the object tracking sensor may be fitted with a cylindrical lens (FIG. 6A) configured to privatize the sensed data. The scene recognition module 445 may include a computing device 447 (i.e., computing device 1650) and scene feature extraction module 449. By way of non-limiting example, the scene feature extraction module 449 may perform feature/scene recognition such as, without limitation, for a head, eyes, nose and mouth locations and sizes, so that a mask can be created. The scene feature extraction module 449 does not intend to perform facial recognition to identify the person to which the face belongs. The feature extraction module 449 may identify features of the object as a vehicle by extracting one or more of tires, doors, bumper style, body length, body height and body contour features.

In some embodiments, the scene recognition module 445 and the computing device 459 may be combined so that the PCDI optics assembly 420 has a centralized computing device structure.

In an embodiment, the private object tracking sensor may include a Microsoft® Kinect® sensor device. The Microsoft® Kinect® sensor includes an RGB (red, green, blue) camera which may serve as the imaging device 450. The Microsoft® Kinect® sensor may include a time-of-flight depth sensor which serves as an object tracking sensor. The depth sensor may include an infrared laser projector. The depth sensor may also include a monochrome complementary metal-oxide-semiconductor (CMOS) sensor, which captures video data in 3D under any ambient light conditions.

In some embodiments, a deblurring or defocusing lens may be placed in front of the lens of the time-of-flight depth sensor to privatize the capture images. In this embodiment, the PCDI optics assembly 420 would include a deblurring lens to be placed in front of the time-of-flight sensor, a beamsplitter 422 and mask generator 432. The modified PCDI optics assembly can be used with other systems which include a camera and object tracking assembly.

The object mask generator 432 may be configured to produce, a K-anonymity face on a display screen, such as a liquid crystal display (LCD) or light emitting display (LED) screen of a display device 457. In some embodiments, the display device 457 may include a projection-type display device wherein a projected output of the display device is directed to the beamsplitter 422. An example, of a K-anonymity face image is shown in FIG. 5B. However, the actual K-anonymity face will vary based on the K−1 nearest neighbors discussed in detail later.

The beamsplitter 422 may include a glass planar member which is generally transparent. One side of the glass planar member may include a first side on which the light rays, represented by Arrow A, carrying the image representative of the scene which may include the target face 402, are incident. The beamsplitter 422 includes a second side on which light rays, represented by Arrow B, carrying the mask 437 (FIG. 5B) from the object mask generator 432, are incident. The composite light rays, represented by Arrow C includes the target face and the mask 437 which when sensed by imaging device 450 produces a de-identifying image where the de-identifying image is a de-identified target face image 470 (FIG. 5C).

In an embodiment, the image representative of the mask 437 may be superimposed on the image representative of the target face 402 to de-identify the target face 402. By way of non-limiting example, the target face 402 and the mask 437 would be aligned so that the composite is well aligned. The target face 402 is not captured by any imaging device. Thus, an image of the target face 402 is not captured in memory, such as of the imaging device 450, or by any device.

While the description describes the de-identification of a face, other objects can be de-identified by privacy. For example, for traffic control, the PCDI system 400 may be used on vehicles, wherein the de-identified object is a vehicle instead of a face. The object tracking sensor 435 would track vehicles and the object mask generator 432 would create a mask for the vehicle. The imaging device 450 would receive from the beamsplitter a composite light ray representative of a de-identified vehicle.

In FIG. 4A, the input k is representative of the number of faces (or object) to anonymize a target face (or object) with. Light from a real target face 402 is merged via a beamsplitter 422 with illumination from a display device 457 showing the k−1 nearest neighbors and captured by an imaging sensor or imaging device 450. The output is a k-anonymized face, directly formed by the PCDI optics assembly 420. Finding the k−1 neighbors, translation alignment and scaling between the target face 402 and the displayed faces of the mask (FIG. 5B) may be achieved using the object tracking sensor 435. FIG. 10A illustrates un-aligned k-anonymized face composite image 1000A. In FIG. 10B, an aligned k-anonymized face composite image 1000B is shown. The tracking sensor 450 may serve to align the mask with the original scene of a face to provide an aligned anonymized face composite image 1000B.

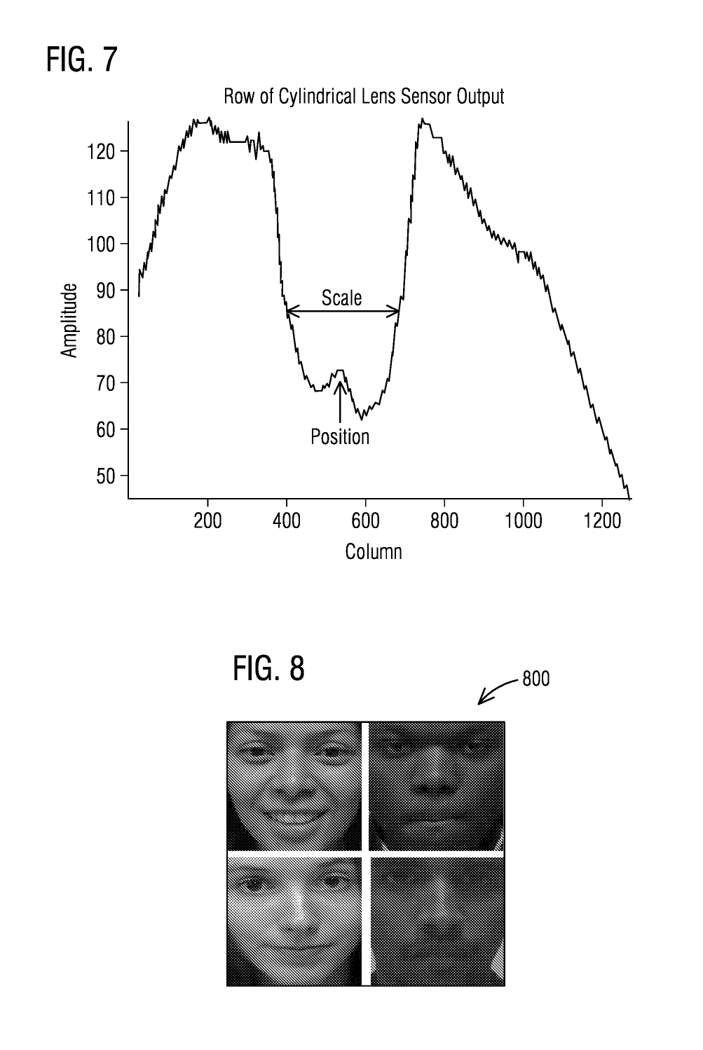

FIG. 6A illustrates a cylindrical lens in a three-dimensional (3D) printed holder with a cylindrical lens in the center of the holder. FIG. 6B illustrates a cylindrical lens sensor output (one row used). FIG. 7 illustrates a graph representative of row of cylindrical lens sensor output by Amplitude on the vertical axis and column for the horizontal axis. The cylindrical lens may create a single line of pixels as the image. The single line of pixels being a linear array. Each pixel in the single line of pixels contains the light from a vertical column of locations in the scene. In this sense, the image may be a vertically compressed or compacted version of the scene. Therefore, such a setup may be sensitive to movement in a horizontal direction. Many scenes may give rise to the same compacted cylindrical image, enforcing privacy. The intensity along this linear image gives the location of the person, since the background is static and (in this case) is a white plane. The person may show up as the darker portion of the linear image. The darkest portion of the linear image may give the location of the person. The location is needed for alignment of the mask with the face or object in the scene.

In an embodiment, only one image row from this sensor may be used, to simulate a linear array. The scale and position of the face can be found by identifying local extrema of the intensity profile.

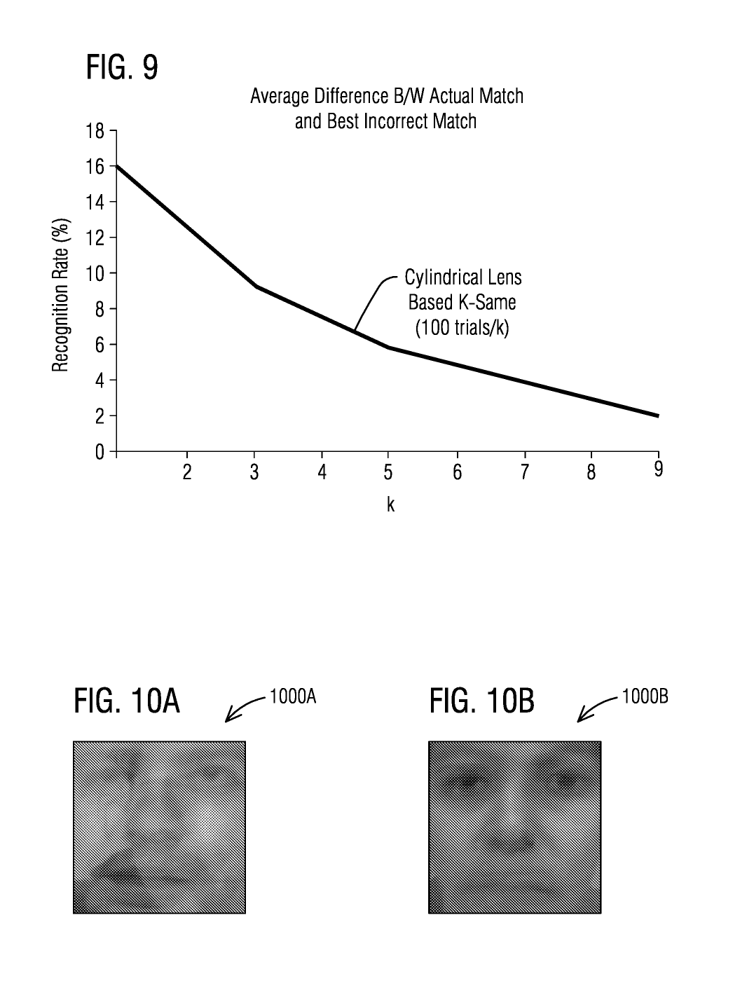

FIG. 8 illustrates a database of a set of a plurality of faces 800, such as for K-same analysis. The database (i.e., database 480) may include additional faces or sets of faces. In an embodiment, the database (i.e., database 480) includes at least one image of the target face for use in process 1800 of FIG. 18. FIG. 9 illustrates a graph representative of an average between an actual match and best incorrect match with a recognition race in percentage (%) on the vertical axis and the value k on the horizontal axis.

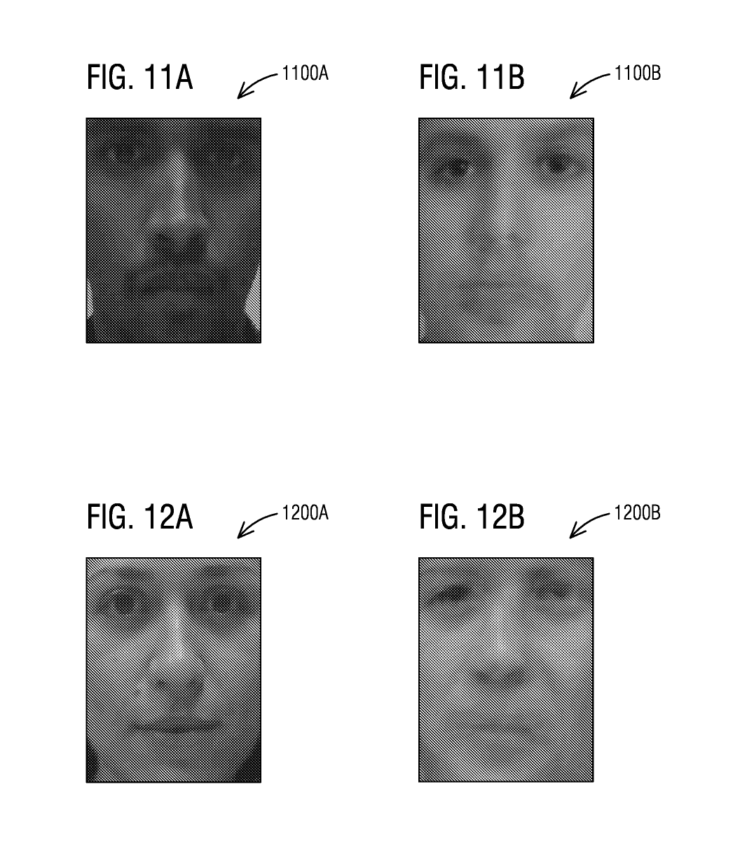

In an embodiment, the PCDI system 100, 300 or 400 may be used to preserve privacy while maintaining an ability to recognize of the target face in a membership class. For example, the membership class may include criminals or terrorist. The target face when captured and processed enables privacy preserving face recognition for individuals in a membership class, such as shown in FIGS. 11A and 11B. However, the system 100, 300 or 400 may maintain anonymity for individuals outside of the membership class, see FIGS. 12A and 12B. The inventors simulated the system using the FERET (Face Recognition Technology) database for k={2, 4, 6, 8, 10} (100 trials/k) and implemented the system using with a membership class of four individuals.

FIG. 11A illustrates a target face 1100A. FIG. 11B illustrates an anonymized or de-identified target face image 1100B de-identified with k-anonymity faces from a database. The target face image was able to be identified in the membership class. FIG. 12A illustrates a target face 1200A. However, FIG. 12B illustrates a de-identified target face image 1200B de-identified with k-anonymity faces in a database. A search of a membership class database did not produce a match. Thus, the k-anonymity composite can be searched in a database of criminals or terrorists for a match while maintaining the privacy of the target face.

The system 100, 300, or 400 may include a variety of different optical designs that perform privacy preserving computations on the incident light-field before capture. A first design may perform optical averaging and enables k-anonymity image capture. A second design may use an aperture mask to perform angular convolutions and enables privacy enhancing image blur.

K-anonymity for faces may include face de-identification by averaging together an image representative of a target face with k−1 of its neighbors (according to some similarity metric). Similarity metric is a function that takes two images and outputs a number. If the number is low, the images are said to be similar according to that metric. If the number is high, the images are said to be non-similar according to the metric, for example. The resulting average image may have an algorithm-invariant face recognition rate bound of 1/k. The PCDI system 400, illustrated in FIG. 4A, may comprise a sensor (approximated by an ideal pinhole camera) whose viewing path is split (via a beamsplitter 422) between the scene, represented along Arrow A, and an active optical mask, represented on Arrow B, such as a projector or electronic display (i.e., mask generator 432). The irradiance I measured at each sensor pixel (x, y) that views a scene point P is given by Equation (1),

$$I ( x , y ) = {e}_{P} {I}_{P} + {e}_{M} {\sum }_{1 \leq i \leq k - 1}^{ } {wiI}_{mask} ( {F}_{i} ( H ( x , y ) ) ) \qquad Equation ( 1 )$$

where I_{P} is the radiance from P (scene point), Fᵢ are digital images of the k−1 nearest neighbors, Iₘₐₛₖ maps a mask pixel intensity to its displayed radiance, wi are user defined blending weights and H is a transformation between the sensor and mask planes. e_{P} and e_{M} are the ratios of the optical path split between the scene and the de-identification mask M, and these can range from 0 to 1. By way of non-limiting example, planar non-polarizing half-mirrors may be used as the beamsplitter 422, so e_{P}=e_{M}=0.5 and the sensor exposure may be doubled to create full intensity k-anonymized images.

In an embodiment, a ViewSonic LED screen (mask generator 432), a Logitech RGB sensor (imaging device 450) and a beamsplitter (Edmund Optics) 422 were used. However, other sensors, beamsplitters and the display device may be used. FIG. 5C represents an initial test result for k=2, where the image neighbor was user selected and aligned.

The remaining results may be created by an automatic k−1 nearest neighbor search on a database of faces t (i.e., database of FIG. 8) or a FERET database using the central row from a second Lumenera Lu-171 grayscale camera with a 6 mm focal length cylindrical lens. In an embodiment, two cylindrical lens sensors at orthogonal orientations may be used to provide 2D translation and scale alignment. A color camera may be used.

In an embodiment, a single sensor having horizontal alignment and scale may be used to produce the images in FIG. 10 wherein vertical alignment may be user controlled or may be generated using a second sensor to track the location of the head in the vertical direction. FIG. 10 shows optical k-anonymity results with and without the cylindrical lens-based alignment. The k−1 faces displayed by the mask generator 432 (i.e., LCD or LED display device) can be aligned off-line in software with using a face alignment process.

In an embodiment, the volume of the optics for small form factor may be generated for glasses, head worn devices, mobile devices and hand-held device, to name a few. In addition, assumed that the k−1 neighbors Fi in Equation (1) are captured under similar illumination environments to the target face.

In an embodiment, the k−1 neighbors Fi in Equation (1) may be captured under dissimilar illumination environments to the target face. In an embodiment, an additional single photo-detector element may be used. The extracting scene features component 325 may include a single photo-detector element or photodiode for just one pixel with no lens or optics. The single photo-detector element or photodiode may collect the light from the scene and therefore give a sense of whether the scene is dark or lit at the particular pixel. There is no way to tell other identifying features in the scene using one pixel. The photo-detector may be privacy preserving as it only captures a single intensity value, to set the linear weights wi in Equation (1) to compensate for the image intensity differences.

In certain embodiments, the mask generator 432 (i.e., display device) may be susceptible to physical tampering that might prevent k-anonymity. Hence, physical tampering should be controlled. In certain embodiments, access to the database may allow an adversary to remove k-anonymity. Hence, care to secure access to the database may be needed.

In an embodiment, the value of the parameter k may be randomized. In an embodiment, the choice of k neighbors and the blending weights wi may be randomized to make de-anonymity combinatorially difficult.

The system 100, 300 or 400 may include a resolution criteria where the resolution of the display may be equal to or greater than the resolution of the sensor. In an embodiment, the camera sensor in FIG. 4A may be miniaturized by a method such as described in S. J. Koppal, I. Gkioulekas, T. Zickler and G. L. Barrows, “Wide-angle micro sensors for vision on a tight budget,” CVPR, 2011, incorporated herein by reference as if set forth in full below.

The illustrations herein show a 2D ray diagram. In an embodiment, the PCDI optics assembly may be symmetric. Hence, these parameters hold in three dimensions. In an embodiment, the beamsplitter angle may be fixed at φ and the sensor field of view (FOV) be θ. Let the minimum size of the mask that still affords the desired resolution be Mmin. The mask may be perpendicular to the reflected optical axis.

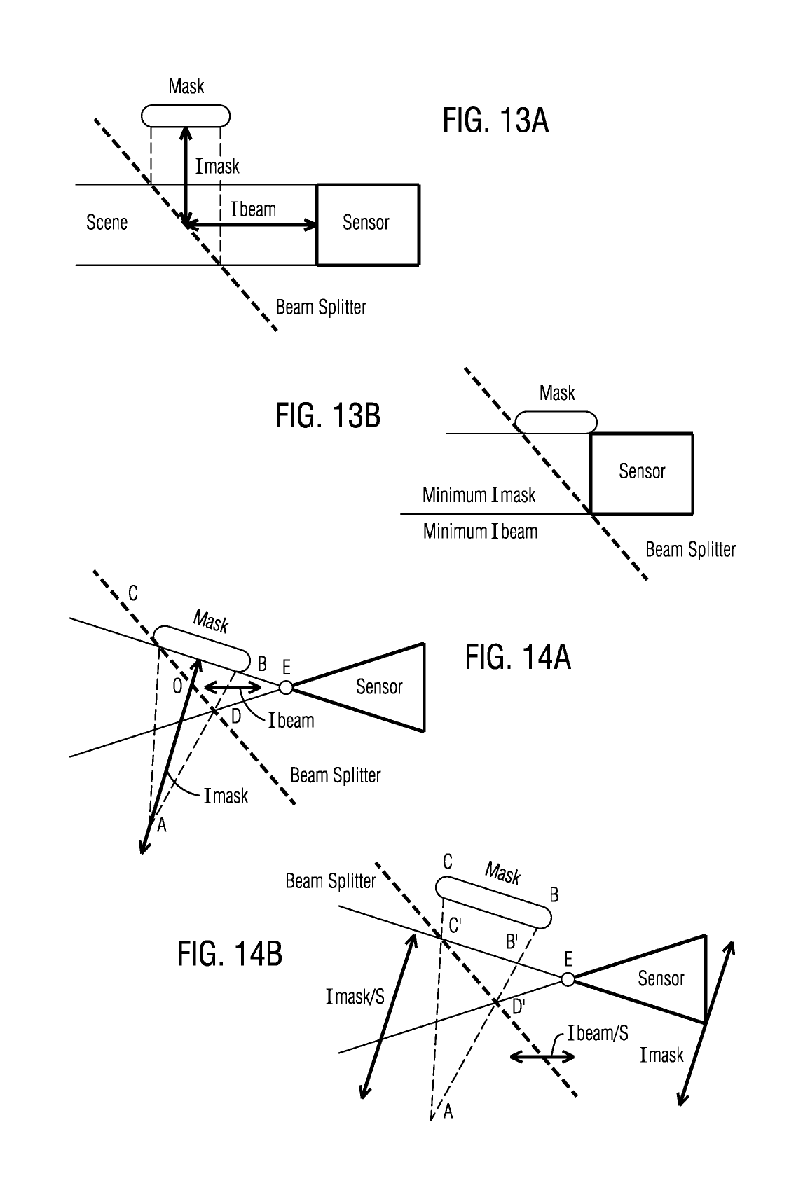

Referring now to FIGS. 13A-13B, in an embodiment, the PCDI optics assembly may provide two degrees of freedom for the k-anonymity optics which may include the sensor-beamsplitter distance lbeam along the sensor's optical axis and the mask-beamsplitter distance lmask along the reflected optical axis. In an orthographic version (FIGS. 13A-13B) of k-anonymity optics (i.e., PCDI 420), the size of the mask may not change as it is translated towards the sensor. Therefore, a mask of minimum size Mmin may be moved as close as possible to the sensor without occluding the field-of-view (FOV). In this illustration, the k-anonymity optics includes the beamsplitter and object mask generator.

In the perspective case, as illustrated in FIGS. 14A-14B, the size of the mask reduces as it slides along the pencil of rays. Pencil of rays means the viewing cone from the camera. Once the minimum mask size Mmin is reached, that configuration may have a minimum optical size, given by ΔCDE's area.

Alternately, in the perspective case, there may be an alternate minimum optical size. To maintain the minimum resolution, any mask portion closer to the sensor must be vertically shifted as in FIG. 14B. The area of the configuration of optics of FIG. 14B is given by ΔC′D′E+C′B′BC. From similar triangles, we can write ΔC′D′E as being created from ΔCDE by scale factor 1/s, and then equate the two configurations in FIGS. 14A and 14B by Equation (2)

$$Δ CDE ( 1 - \frac{1}{s} ) = C ’ B ’ BC . \qquad Equation ( 2 )$$

Consider ΔCDE=ΔCOE+ΔODE (FIG. 14A). From the angle-side-angle theorem, this becomes, Equation (3)

$$Δ CDE = \frac{{I}_{beam}^{2} sin \frac{θ}{2} sin ∅}{2 sin ( \frac{θ}{2} - ∅ )} + \frac{{I}_{beam}^{2} sin \frac{θ}{2} sin ∅}{2 sin ( \frac{θ}{2} + ∅ )} . \qquad Equation ( 3 )$$

Since ΔAB′C′ is a scaled version of ΔABC, the quadrilateral area C′B′BC=defined by Equation (4)

$$Δ ABC ( 1 - \frac{1}{{s}^{2}} ) = \frac{{M}_{min} {I}_{mask}}{2} ( 1 - \frac{1}{{s}^{2}} ) . \qquad Equation ( 4 )$$

Putting Equation (3) and Equation (4) into Equation (2) and setting constants of Equations (5a) and 5(b)

$$\begin{matrix}{C}_{1} = \frac{sin \frac{θ}{2} sin ∅}{2 sin ( \frac{θ}{2} - ∅ )} + \frac{sin \frac{θ}{2} sin ∅}{2 sin ( \frac{θ}{2} + ∅ )} & Equation ( 5 a ) \\ s = \frac{{M}_{min} {I}_{mask}}{2 {C}_{1} {l}_{beam}^{2} - {M}_{min} {I}_{mask}} & Equation ( 5 b )\end{matrix}$$

which is an equation for the scaling factor s such that the two (non-limiting) design configuration in FIGS. 14A and 14B have the same area. By way of non-limiting examples, the design configurations may be configured to provide a required resolution within the smallest optical dimensions.

In an embodiment, optical k-same may be used to allow recognition of membership to a class while preserving privacy. Each target is first anonymized via optical k-same with k−1 faces corresponding to individuals that are not in the membership class and are not known to the party performing face recognition. The de-identified or anonymized face is compared to each face in the membership class using a similarity metric. If the similarity score is greater than a threshold then the de-identified or anonymized face is matched with that individual. With no match, the system 100, 300 or 400 returns the k-anonymized face. K-same is the process of selecting the set of similar faces or objects in the database 380. K-anonymity is the anonymity given the person as a result of the process. In other words, the face illustrated in FIG. 5C has k-anonymity. However, in some instances as described herein, k-same and k-anonymity may be interchangeable.

Returning again to FIGS. 12A-12B, the inventors simulated the PCDI system using two subsets of the FERET Database, each containing a single image of a plurality of images, each image of the plurality being a different person where every person is represented by only one image of a set of people. For k={2, 4, 6, 8, 10}, 100 individuals from one subset were randomly selected as targets and anonymized with their k−1 nearest neighbors found in the same subset by simulating the effect of the cylindrical lens by integrating the image vertically and matching with the cosine similarity. The similarity between this k-anonymized image and 11 other images from the second image subset was then computed using Face++'s verification algorithms. One of these is the target image from the second image subset, while the remaining were randomly selected. A comparison of the similarities is shown in 12A-12B. A 2FPS system was built using this idea and the figure shows examples where individuals were correctly discriminated. FPS stands for frame per second.

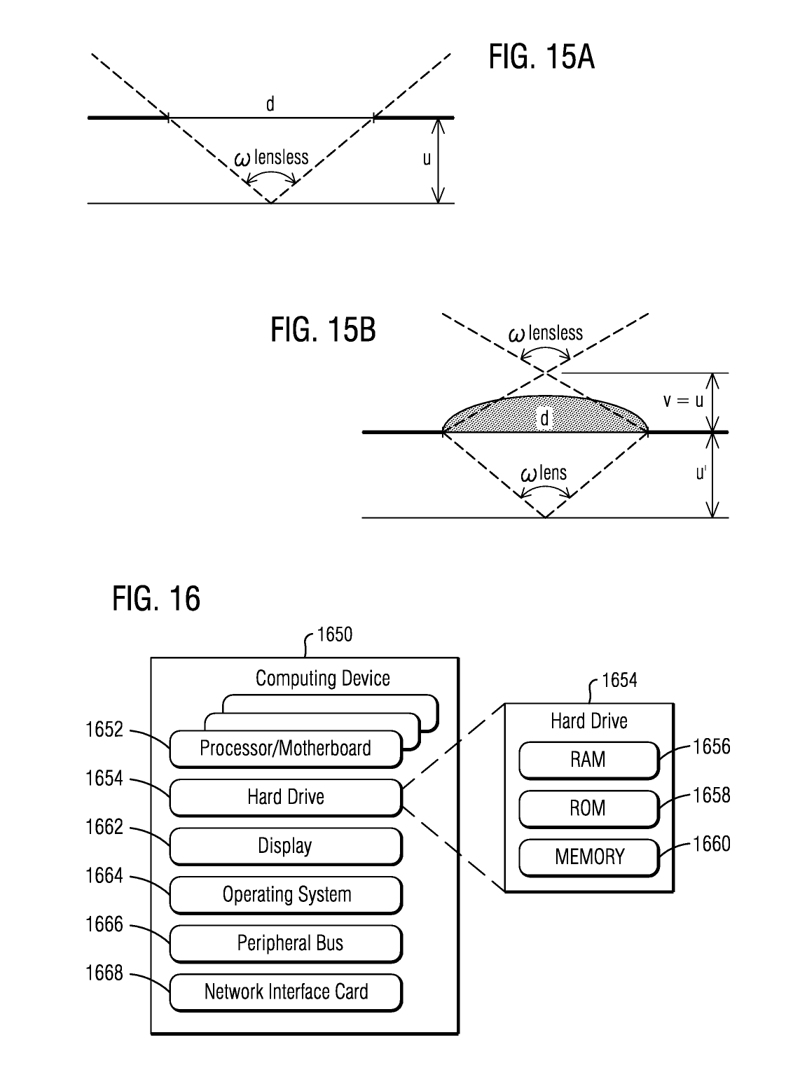

FIG. 15A illustrates a lensless sensor configuration which may be used for defocus. FIG. 15B illustrates a lenslet sensor configuration which may be used for defocus of the object tracking sensor 435. FIG. 15B illustrates that a lenslet sensor of diameter d and image distance u can be modeled as a lensless sensor of height u and pinhole size d. The parameters ωₗₑₙₛₗₑₛₛ and ωₗₑₙₗₑₜ represent the extent of blur for these designs.

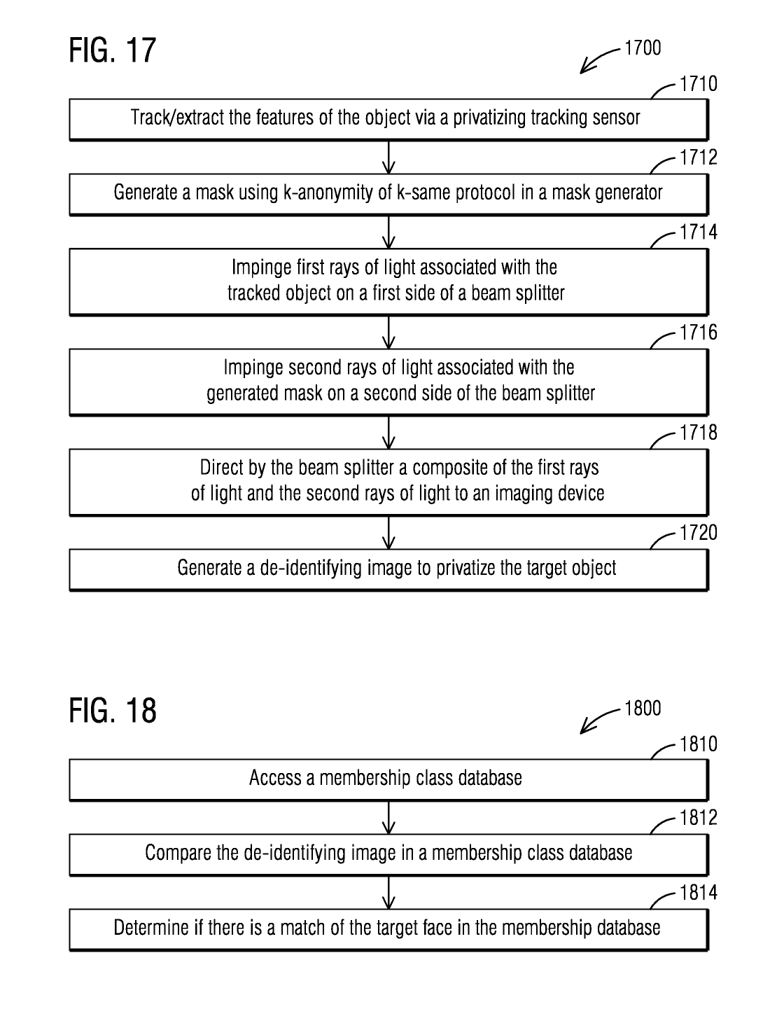

FIG. 17 illustrates a flow diagram of a process 1700 for de-identifying or anonymizing a target face or object without storing the original target face or object in memory of the imaging device. The process 1700 will be described in relation to FIGS. 4A and 4B. At block 1710, the features of the object are tracked/extracted. In an embodiment, the object tracking sensor 435 may be a privatizing object tracking sensor such that the identity of the object or person being tracked remains private. No image of the object that is identifiable is stored by the object tracking sensor. The tracked/extracted features may include one or more of a location, speed, pose, and orientation and depth of an object in the scene.

At block 1712, a mask is generated using k-anonymity or k-same protocol by a mask generator 432. Nonetheless, other anonymity protocols may be used. The generated mask when communicated (such as by illumination) to the beamsplitter 422 which may be configured so that the mask is generally aligned with the target object light vertically and horizontally. The mask may be superimposed over the target object light. For example, for a face, the eyes of the target face and the eyes of the mask should be aligned. The mouth and nose of mask may be aligned with the mouth and nose of the target face. By way of non-limiting example, for a vehicle, components of a vehicle may be aligned with similar component of the mask, such as, wheels, windows, doors, etc. At block 1714, first rays of light associated with the tracked object are impinged on a first side of the beamsplitter 422. At block 1716, second rays of light associated with the generated mask, by the mask generator 432, are impinged on a second side of the beamsplitter 422. At block 1718, the beamsplitter 422 directs a composite of the first rays of light and the second rays of light to an imaging device 450. At block 1720, de-identifying image is generated or captured by the imaging device as the composite rays of light at the image sensors of the imaging device are sensed. The resultant sensed composite rays being a de-identifying image or anonymized image which may be stored by the imaging device 450 in memory.

The image of the target object is privatized and not stored in memory of the imaging device until anonymized or de-identified with a mask of the PCDI optics assembly 420. As can be appreciated, one or more of the steps may be performed in the order shown or a different order. For example, one or more of the steps may be performed simultaneously.

FIG. 18 illustrates a flow diagram of a process 1800 for identifying a member in a membership class database using a de-identified face image. At block 1810, the membership class database is accessed. At block 1812, the de-identifying image is compared to images in the membership class database such as by using facial recognition protocols. At block 1814, a determination is made whether there is a match between the de-identifying image and the images in the membership class database. In some embodiments, the imaging device 450 may be part of a system to identify terrorist, persons on a no-fly list, persons of interest or criminals. The imaging device (i.e., imaging device 450) may communicate wirelessly or wired with a computing device or server connected to a database with the membership class database.

FIG. 16 illustrates a computing device 1650. Computing device 1650 may include one or more processors 1652 and system memory in hard drive 1654. Depending on the exact configuration and type of computing device, system memory may be volatile (such as RAM 1656), non-volatile (such as read only memory (ROM 1658), flash memory 1660, and the like) or some combination of the two. System memory may store operating system 1664, one or more applications, and may include program data for performing acts of processes 1700 and 1800. The computing device 1650 may carry out one or more blocks of processes 1700 and 1800. Computing device 1650 may also have additional features or functionality. For example, computing device 1650 may also include additional data storage devices (removable and/or non-removable) such as, for example, magnetic disks, optical disks, or tape. Computer storage media may include volatile and non-volatile, non-transitory, removable and non-removable media implemented in any method or technology for storage of data, such as computer readable instructions, data structures, program modules or other data. System memory, removable storage and non-removable storage are all examples of computer storage media. Computer storage media includes, but is not limited to, RAM, ROM, Electrically Erasable Read-Only Memory (EEPROM), flash memory or other memory technology, compact-disc-read-only memory (CD-ROM), digital versatile disks (DVD) or other optical storage, magnetic cassettes, magnetic tape, magnetic disk storage or other magnetic storage devices, or any other physical medium which can be used to store the desired data and which can be accessed by computing device. Any such computer storage media may be part of device. The code may be in a non-transitory, tangible computer readable medium.

Computing device 1650 may also include or have interfaces for input device(s) (not shown) such as a keyboard, mouse, pen, voice input device, touch input device, etc. The computing device 1650 may include or have interfaces for connection to output device(s) such as a display 1662, speakers, etc. The computing device 1650 may include a peripheral bus 1666 for connecting to peripherals. Computing device 1650 may contain communication connection(s) that allow the device to communicate with other computing devices, such as over a network or a wireless network. By way of example, and not limitation, communication connection(s) may include wired media such as a wired network or direct-wired connection, and wireless media such as acoustic, radio frequency (RF), infrared and other wireless media. The computing device 1650 may include a network interface card 1668 to connect (wired or wireless) to a network.

Computer program code for carrying out operations described above may be written in a variety of programming languages, including but not limited to a high-level programming language, such as without limitation, C or C++, for development convenience. In addition, computer program code for carrying out operations of embodiments described herein may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed Digital Signal Processor (DSP) or microcontroller. A code in which a program of the embodiments is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD).

The embodiments may be configured for use in a computer or a data processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps for creating a new machine. The general purpose computer becomes a special purpose computer once it is programmed to perform particular functions pursuant to instructions from program software of the embodiments described herein. The instructions of the software program that carry out the algorithm/steps electrically change the general purpose computer by creating electrical paths within the device. These electrical paths create a special purpose machine for carrying out the particular algorithm/steps.

Unless otherwise defined, all terms (including technical and scientific terms) used herein have the same meaning as commonly understood by one of ordinary skill in the art to which embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In particular, unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such data storage, transmission or display devices.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

We claim:

1. A de-identification assembly comprising:
an object tracking sensor (435) to track and extract features of an object;
a mask generator (432) to produce rays of light in response to the tracked features of the object, the rays of light representing a de-identification mask of the object; and
a beamsplitter (422) having a first side configured to receive rays of light representing an object and a second side configured to receive the rays of light from the mask generator (432), the beamsplitter (422) producing a composite image of the object superimposed with the de-identification mask.

2. The assembly according to claim 1, wherein the object tracking sensor (435) is a privatizing object tracking sensor such that identification of the object is privatized in optics.

3. The assembly according to claim 1, further comprising a database (480) of a plurality of objects, wherein the de-identification mask includes K-anonymity objects varied based on the K−1 nearest neighbors, where K is an integer greater than 1.

4. The assembly according to claim 3, wherein the object includes a face or a vehicle.

5. The assembly according to claim 1, wherein the object is a face; and
further comprising a database (480) of a plurality of K-same images, wherein the de-identification mask is a K-same faces varied based on the K−1 nearest neighbors, where K is an integer greater than 1.

6. The assembly according to claim 1, wherein the object tracking sensor (435) comprises a cylindrical lens coupled to a lens of an object tracking sensor (435) to privatize the sensed data.

7. The assembly according to claim 1, wherein object tracking sensor (435) comprises a sensor configured to privately detect location, speed, and orientation and depth of the object.

8. A system comprising:
an object tracking sensor (435) to track and extract features of an object;
a mask generator (432) to produce rays of light in response to the tracked and extracted features of the object, the rays of light representing a de-identification mask of the object;
a beamsplitter (422) having a first side configured to receive rays of light representing an object and a second side configured to receive the rays of light from the mask generator (422), the beamsplitter (422) to produce a composite image of the object superimposed with the de-identification mask; and
an imaging device (450) to capture an image of the composite image wherein the composite image being anonymized image of the object.

9. The system according to claim 8, wherein the object tracking sensor (435) is a privatizing object tracking sensor such that identification of the object is privatized in optics.

10. The system according to claim 8, further comprising a database (480) of a plurality of objects, wherein the de-identification mask is a K-anonymity objects varied based on the K−1 nearest neighbors, where K is an integer greater than 1.

11. The system according to claim 10, wherein the object includes a face or a vehicle.

12. The system according to claim 8, wherein the object is a face; and
further comprising a database (480) of a plurality of K-same images, wherein the de-identification mask is a K-same faces varied based on the K−1 nearest neighbors, where K is an integer greater than 1.

13. The system according to claim 8, wherein the object tracking sensor (435) comprises a cylindrical lens coupled to a lens of an object tracking sensor to privatize the sensed data.

14. The system according to claim 8, wherein object tracking sensor (435) comprises a sensor configured to privately detect location, speed, and orientation and depth of the object.

15. The system according to claim 8, wherein the imaging device includes a wearable imaging device.

16. The system according to claim 15, wherein the wearable imaging device includes one of smart glasses, camera/video enabled goggles, body worn video camera, and camera/video enabled helmets.

17. A method comprising:
tracking, by an object tracking sensor (435), features of an object;
generating, by a mask generator (432), rays of light in response to the tracked features of the object, the rays of light representing a de-identification mask of the object; and
receiving, at a first side of a beamsplitter (422), rays of light representing an object;
receiving, at a second side of the beamsplitter (422), the rays of light of the de-identification mask from the mask generator (432);
generating, by the beamsplitter (422), a composite image of the object superimposed with the de-identification mask.

18. The method of claim 17, further comprising communicating rays of light representing the composite image from the beamsplitter (422) to an imaging device (450); and storing an image representative of the composite image, wherein the composite image is an anonymized image of the object.

19. The method of claim 18, wherein the tracking step includes: during the tracking, privatizing the tracking in optics.

20. The method of claim 18, wherein an image of original features of the object is not stored in memory.
